(19) United States
(12) Patent Application Publication
(10) Pub. No.: US 2025/0023047 A1
(43) Pub. Date: Jan. 16, 2025

(54) "LITHIUM SECONDARY BATTERY POSITIVE ELECTRODE MATERIAL INCLUDING CAFFEINE ORGANIC MATERIAL AND METHOD FOR PRODUCING SAME"

(71) Applicant: Research & Business Foundation SUNGKYUNKWAN UNIVERSITY, Suwon-si (KR)

(72) Inventors: Wontae LEE, Daegu (KR); Won Sub YOON, Seoul (KR); Sung Ho KONG, Yongin-si (KR); Mun Hyeok CHOI, Suwon-si (KR)

(73) Assignee: Research & Business Foundation SUNGKYUNKWAN UNIVERSITY, Suwon-si (KR)

(21) Appl. No.: 18/764,819

(22) Filed: Jul. 5, 2024

(30) Foreign Application Priority Data
Jul. 11, 2023 (KR) 10-2023-0089743

(51) Int. Cl. H01M 4/60; H01M 4/02; H01M 4/04; H01M 4/62; H01M 10/0525

(52) U.S. Cl. CPC H01M 4/60; H01M 4/043; H01M 4/622; H01M 4/625; H01M 10/0525; H01M 2004/021; H01M 2004/028

(57) ABSTRACT

An embodiment of the disclosure provides a positive electrode material for a lithium secondary battery and a method for producing the same, which uses a caffeine organic material as the positive electrode material of the lithium secondary battery.

### CROSS REFERENCE TO RELATED APPLICATION

The present application claims priority to Korean Patent Application No. 10-2023-0089743, filed on Jul. 11, 2023, the entire contents of which is incorporated herein for all purposes by this reference.

### BACKGROUND

### Field of the Invention

The disclosure relates to a positive electrode material for a lithium secondary battery including a caffeine organic material and a method for producing the same, and more specifically, to a positive electrode material for a lithium secondary battery using a caffeine organic material as the positive electrode material of the lithium secondary battery and a method for producing the same.

The positive electrode material currently leading the lithium-ion battery market is high-voltage LiCoO₂ for small-sized batteries, and layered transition metal composite oxides such as Li (Ni-Co-Mn or Ni-Co-Al)O₂ for medium to large-sized batteries.

However, these positive electrode materials are composed of inorganic compounds, and the amount of their constituent elements is very small compared to soil, seawater, atmosphere, and biomass. In addition, since these elements inevitably cause environmental problems during the acquisition process, the development of positive electrode materials from a new perspective is necessary for sustainable development.

Unlike inorganic compound materials, organic compounds are composed of elements such as C, H, O, N, and S, which are relatively light and have a large price advantage compared to inorganic metals. In addition, there is infinite variety in designing electrode materials, and their soft properties are advantageous in making flexible electrodes.

In the case of organic materials, there is a disadvantage of low reaction potential when used as an anode, but due to their light atomic weight, they can exhibit high energy densities such as 960 to 1100 Wh kg⁻¹ depending on the battery design. In the case of organic material-based electrode materials, there are various types of compounds such as conductive polymers, carbonyls, organosulfur compounds, and organic radicals. These organic electrode materials may be artificially synthesized and are also found in nature. At this time, the use of low-toxicity natural materials is an attractive approach in terms of eco-friendliness, sustainability, and biological safety.

However, organic compound materials have problems such as low electrical conductivity, low redox reaction potential, and dissolution in existing liquid organic electrolyte environments, and these are each correlated with battery performance such as rate capability, energy density, and cyclability. To solve this, an understanding of the energy storage mechanism of the organic material must come first.

### RELATED ART DOCUMENT

### Patent Document

Republic of Korea Patent No. 10-0593860

### SUMMARY

An aspect of the disclosure is to provide a positive electrode material for a lithium secondary battery and a method for producing the same by applying a caffeine organic material as the positive electrode material of the lithium secondary battery.

The aspect of the disclosure is not limited to that mentioned above, and other aspects not mentioned will be clearly understood by those skilled in the art from the description below.

An embodiment of the disclosure provides a positive electrode material for a lithium secondary battery.

The positive electrode material for a lithium secondary battery according to an embodiment may have an amorphous thin film structure including a caffeine organic material, and may be characterized by exhibiting reversible energy capacity through a reversible reaction in which lithium ions form and dissociate C6—O—Li and N3—Li—C8 bonds with the caffeine organic material.

In addition, according to an embodiment of the disclosure, the amorphous thin film structure may have a thickness of 30 μm to 36 μm.

Another embodiment of the disclosure provides a lithium secondary battery.

According to another embodiment of the disclosure, the lithium secondary battery may include:

a positive electrode; a negative electrode; and an ion exchange membrane positioned between the positive electrode and the negative electrode, wherein the positive electrode includes a positive electrode material for a lithium secondary battery.

Another embodiment of the disclosure provides a method for producing a positive electrode material for a lithium secondary battery.

According to another embodiment of the disclosure, the method for producing a positive electrode material for a lithium secondary battery may include:
forming a slurry by mixing a caffeine organic material, a conductive material, and a polymer binder with a solvent; coating the formed slurry on a substrate; drying the substrate coated with the slurry in a vacuum to form a film; and forming a thin film by pressing the formed film.

In addition, according to an embodiment of the disclosure, the forming of the slurry may include:
ball-milling a mixture including the caffeine organic material and the conductive material to make the mixture amorphous; and
mixing the amorphous mixture with the polymer binder and the solvent.

In addition, according to an embodiment of the disclosure, the ball-milling of the mixture to make the mixture amorphous
may be performed for 30 to 60 minutes at 200 to 400 rpm.

In addition, according to an embodiment of the disclosure, the conductive material may be at least one selected from the group consisting of Super P, Carbon black, CNT, and Ketjen Black.

In addition, according to an embodiment of the disclosure, the polymer binder may be at least one selected from PVDF and PAA.

In addition, according to an embodiment of the disclosure, the solvent may be N-methylpyrrolidone.

In addition, according to an embodiment of the disclosure, in the forming of the slurry,
the mixing ratio of the caffeine organic material, conductive material, and polymer binder may correspond to a weight ratio of 3:6:1 to 6:3:1.

In addition, according to an embodiment of the disclosure, in the coating, the substrate may be aluminum foil.

In addition, according to an embodiment of the disclosure, the drying in a vacuum to form the film may be performed for 10 to 15 hours at a temperature range of 60° C. to 80° C.

In addition, according to an embodiment of the disclosure, in the forming of the thin film by pressing, the thickness of the thin film may be 30 μm to 36 μm.

According to an embodiment of the disclosure, a positive electrode material for a lithium secondary battery and a method for producing the same can be provided by applying a caffeine organic material as a positive electrode material for a lithium secondary battery.

According to an embodiment of the disclosure, caffeine (1,3,7-trimethylpurine-2,6-dione), a natural compound, can be used as an energy storage material, and an optimized condition for a battery system to which the positive electrode material for a lithium secondary battery is applied can be provided.

According to an embodiment of the disclosure, an energy storage mechanism of a caffeine molecule can be provided.

The effects of the disclosure are not limited to the effects described above, and should be understood to include all effects that are inferable from the configuration of the disclosure described in the detailed description or claims of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram showing the operating principle of a lithium secondary battery and a positive electrode material for a lithium secondary battery according to an embodiment of the disclosure;

FIG. 2 is a schematic diagram showing the positive electrode material for a lithium secondary battery and the production process of a lithium secondary battery according to an embodiment of the disclosure;

FIG. 3 is a table showing electrode production and battery assembly conditions for implementing optimal performance as a lithium secondary battery according to an embodiment of the disclosure;

FIG. 4A is a graph showing the results of an electrochemical characteristic evaluation when Super P is used as the conductive material in the production process of a lithium secondary battery according to an embodiment of the disclosure;

FIG. 4B is a graph showing the results of an electrochemical characteristic evaluation when Carbon Black is used as the conductive material in the production process of a lithium secondary battery according to an embodiment of the disclosure;

FIG. 4C is a graph showing the results of an electrochemical characteristic evaluation when CNT (Carbon Nanotubes) is used as the conductive material in the production process of a lithium secondary battery according to an embodiment of the disclosure;

FIG. 4D is a graph showing the results of an electrochemical characteristic evaluation when Ketjen Black is used as the conductive material in the production process of a lithium secondary battery according to an embodiment of the disclosure;

FIG. 5A is a graph showing the results of an electrochemical characteristic evaluation when PVDF (Polyvinylidene Fluoride) is used as the polymer binder in the production process of a lithium secondary battery according to an embodiment of the disclosure;

FIG. 5B is a graph showing the results of an electrochemical characteristic evaluation when PAA (Polyacrylic Acid) is used as the polymer binder in the production process of a lithium secondary battery according to an embodiment of the disclosure;

FIG. 6A is a graph showing the results of an electrochemical characteristic evaluation when the ball milling condition is 400 rpm for 30 minutes during the production process of a lithium secondary battery according to an embodiment of the disclosure;

FIG. 6B is a graph showing the results of an electrochemical characteristic evaluation when the ball milling condition is 200 rpm for 30 minutes during the production process of a lithium secondary battery according to an embodiment of the disclosure;

FIG. 6C is a graph showing the results of an electrochemical characteristic evaluation when the ball milling condition is 400 rpm for 1 hour during the production process of a lithium secondary battery according to an embodiment of the disclosure;

FIG. 6D is a graph showing the results of an electrochemical characteristic evaluation when the ball milling condition is 200 rpm for 1 hour during the production process of a lithium secondary battery according to an embodiment of the disclosure;

FIG. 7A is a graph showing the results of an electrochemical characteristic evaluation when the amount of solvent used is 0.25 g during the production process of a lithium secondary battery according to an embodiment of the disclosure;

FIG. 7B is a graph showing the results of an electrochemical characteristic evaluation when the amount of solvent used is 0.30 g during the production process of a lithium secondary battery according to an embodiment of the disclosure;

FIG. 7C is a graph showing the results of an electrochemical characteristic evaluation when the amount of solvent used is 0.35 g during the production process of a lithium secondary battery according to an embodiment of the disclosure;

FIG. 7D is a graph showing the results of an electrochemical characteristic evaluation when the amount of solvent used is 0.40 g during the production process of a lithium secondary battery according to an embodiment of the disclosure;

FIG. 7E is a graph showing the results of an electrochemical characteristic evaluation when the amount of solvent used is 0.45 g during the production process of a lithium secondary battery according to an embodiment of the disclosure; FIG. 7F is a graph showing the results of an electrochemical characteristic evaluation when the amount of solvent used is 0.50 g during the production process of a lithium secondary battery according to an embodiment of the disclosure;

FIG. 8A is a graph showing the results of an electrochemical characteristic evaluation when the thin film thickness of the positive electrode material is 38 μm for a lithium secondary battery according to an embodiment of the disclosure;

FIG. 8B is a graph showing the results of an electrochemical characteristic evaluation when the thin film thickness of the positive electrode material is 36 μm for a lithium secondary battery according to an embodiment of the disclosure;

FIG. 8C is a graph showing the results of an electrochemical characteristic evaluation when the thin film thickness of the positive electrode material is 35 μm for a lithium secondary battery according to an embodiment of the disclosure;

FIG. 8D is a graph showing the results of an electrochemical characteristic evaluation when the thin film thickness of the positive electrode material is 33 μm for a lithium secondary battery according to an embodiment of the disclosure;

FIG. 8E is a graph showing the results of an electrochemical characteristic evaluation when the thin film thickness of the positive electrode material is 31 μm for a lithium secondary battery according to an embodiment of the disclosure;

FIG. 9A is a graph showing the results of an electrochemical characteristic evaluation when the electrolyte used is 1M LiPF6 in EC/DEC during the production process of a lithium secondary battery according to an embodiment of the disclosure;

FIG. 9B is a graph showing the results of an electrochemical characteristic evaluation when the electrolyte used is 1M LiPF6 in EC/DMC during the production process of a lithium secondary battery according to an embodiment of the disclosure;

FIG. 9C is a graph showing the results of an electrochemical characteristic evaluation when the electrolyte used is 1M LiTFSI in TEGDME during the production process of a lithium secondary battery according to an embodiment of the disclosure;

FIG. 10A is a graph showing the results of an electrochemical characteristic evaluation when the charge and discharge voltage range is 0.0V to 4.3V during the production process of a lithium secondary battery according to an embodiment of the disclosure;

FIG. 10B is a graph showing the results of an electrochemical characteristic evaluation when the charge and discharge voltage range is 0.5V to 4.3V during the production process of a lithium secondary battery according to an embodiment of the disclosure;

FIG. 10C is a graph showing the results of an electrochemical characteristic evaluation when the charge and discharge voltage range is 1.0V to 4.3V during the production process of a lithium secondary battery according to an embodiment of the disclosure;

FIG. 10D is a graph showing the results of an electrochemical characteristic evaluation when the charge and discharge voltage range is 1.5V to 4.3V during the production process of a lithium secondary battery according to an embodiment of the disclosure;

FIG. 11A is a graph showing the results of evaluating the electrochemical characteristics when the mixing ratio of caffeine organic material, conductive material, and polymer binder is 80:10:10 during the production process of a lithium secondary battery according to an embodiment of the disclosure;

FIG. 11B is a graph showing the results of evaluating the electrochemical characteristics when the mixing ratio of caffeine organic material, conductive material, and polymer binder is 70:20:10 during the production process of a lithium secondary battery according to an embodiment of the disclosure;

FIG. 11C is a graph showing the results of evaluating the electrochemical characteristics when the mixing ratio of caffeine organic material, conductive material, and polymer binder is 60:30:10 during the production process of a lithium secondary battery according to an embodiment of the disclosure;

FIG. 11D is a graph showing the results of evaluating the electrochemical characteristics when the mixing ratio of caffeine organic material, conductive material, and polymer binder is 50:40:10 during the production process of a lithium secondary battery according to an embodiment of the disclosure;

FIG. 11E is a graph showing the results of evaluating the electrochemical characteristics when the mixing ratio of caffeine organic material, conductive material, and polymer binder is 40:50:10 during the production process of a lithium secondary battery according to an embodiment of the disclosure;

FIG. 11F is a graph showing the results of evaluating the electrochemical characteristics when the mixing ratio of caffeine organic material, conductive material, and polymer binder is 30:60:10 during the production process of a lithium secondary battery according to an embodiment of the disclosure;

FIG. 12A is a graph showing the results of X-ray diffraction analysis of a positive electrode material for a lithium secondary battery according to an embodiment of the disclosure.

FIG. 12B is a schematic diagram briefly representing the amorphous phase of the positive electrode material for a lithium secondary battery according to an embodiment of the disclosure.

FIG. 13A is a graph showing the results of C-NMR analysis of a positive electrode material for a lithium secondary battery according to an embodiment of the disclosure;

FIG. 13B is a graph showing the results of H-NMR analysis of a positive electrode material for a lithium secondary battery according to an embodiment of the disclosure;

FIG. 14A is a graph showing the charge-discharge evaluation results of a lithium secondary battery according to an embodiment of the disclosure, plotting voltage (V) against capacity (mAh/g);

FIG. 14B is a graph showing the charge-discharge evaluation results of a lithium secondary battery according to an embodiment of the disclosure, plotting current (mA) against voltage (V vs. Li/Li⁺).

FIG. 15 is a graph showing IR spectra of four state-of-charge states of a lithium secondary battery according to an embodiment of the disclosure;

FIG. 16A is a schematic diagram showing the peaks of carbon observed at the C1, C3, C5, and C7 positions in a caffeine molecule during XPS measurement of a lithium secondary battery according to an embodiment of the disclosure;

FIG. 16B is a schematic diagram showing the peaks of carbon observed at the C6 position in a caffeine molecule during XPS measurement of a lithium secondary battery according to an embodiment of the disclosure;

FIG. 16C is a schematic diagram showing the peaks of carbon observed at the C4 and C8 positions in a caffeine molecule during XPS measurement of a lithium secondary battery according to an embodiment of the disclosure;

FIG. 16D is a schematic diagram showing the peaks of carbon observed at the C2 position in a caffeine molecule during XPS measurement of a lithium secondary battery according to an embodiment of the disclosure;

FIG. 16E is a schematic diagram showing the peaks of nitrogen observed in a caffeine molecule during XPS measurement of a lithium secondary battery according to an embodiment of the disclosure;

FIG. 16F is a schematic diagram showing the peaks of oxygen observed in a caffeine molecule during XPS measurement of a lithium secondary battery according to an embodiment of the disclosure;

FIG. 17A is a graph showing the results of XPS measurement of C element in a caffeine molecule in a charged state of a lithium secondary battery according to an embodiment of the disclosure;

FIG. 17B is a graph showing the results of XPS measurement of C element in a caffeine molecule in a discharged state of a lithium secondary battery according to an embodiment of the disclosure;

FIG. 17C is a graph showing the results of XPS measurement of N element in caffeine molecules in a charged state of a lithium secondary battery according to an embodiment of the disclosure;

FIG. 17D is a graph showing the results of XPS measurement of N element in caffeine molecules in a discharged state of a lithium secondary battery according to an embodiment of the disclosure;

FIG. 17E is a graph showing the results of XPS measurement of O element in caffeine molecules in a charged state of a lithium secondary battery according to an embodiment of the disclosure; and

FIG. 17F is a graph showing the results of XPS measurement of O element in caffeine molecules in a discharged state of a lithium secondary battery according to an embodiment of the disclosure.

### DETAILED DESCRIPTION

Hereinafter, the disclosure will be described with reference to the accompanying drawings. However, the disclosure may be implemented in various different forms, and therefore is not limited to the embodiments described herein. In addition, in order to clearly describe the disclosure in the drawings, parts that are not related to the description are omitted, and similar parts are given similar drawing reference numerals throughout the specification.

In the entire specification, when a part is said to be “connected (connected, contacted, coupled)” to another part, this includes not only the case where it is “directly connected” but also the case where it is “indirectly connected” with another member in between. In addition, when a part is said to “include” a certain component, this does not mean that other components are excluded unless otherwise specifically stated, but that other components may be additionally provided.

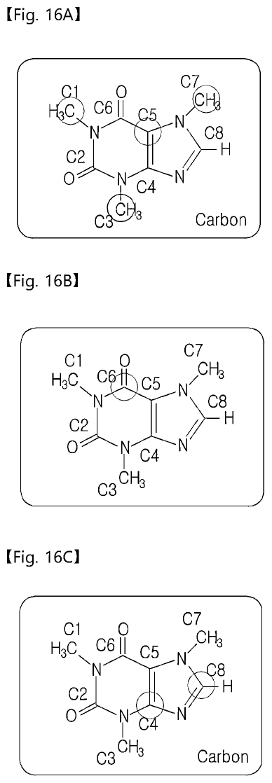

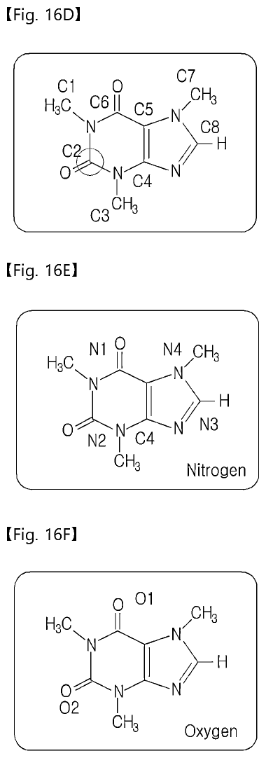

In the entire specification, C1 to C7, N1 to N4, and O1 to O2 are named according to the positions of each atom in the chemical formula of the caffeine organic material, as expressed in FIG. 16.

The terms used in this specification are used only to describe specific embodiments and are not intended to limit the disclosure. The singular expression includes the plural expression unless the context clearly indicates otherwise. In this specification, the terms “include” or “have” are intended to specify the presence of a feature, number, step, operation, component, part, or combination thereof described in the specification, but should be understood as not excluding in advance the possibility of the presence or addition of one or more other features, numbers, steps, operations, components, parts, or combinations thereof.

Hereinafter, embodiments of the disclosure will be described in detail with reference to the accompanying drawings.

A positive electrode material for a lithium secondary battery according to one embodiment of the disclosure is described.

As an example of the embodiment, there may be a positive electrode material for a lithium secondary battery, characterized by having an amorphous thin film structure including a caffeine organic material, and may be characterized by exhibiting reversible energy capacity through a reversible reaction in which lithium ions form and dissociate C6—O—Li and N3—Li—C8 bonds with the caffeine organic material.

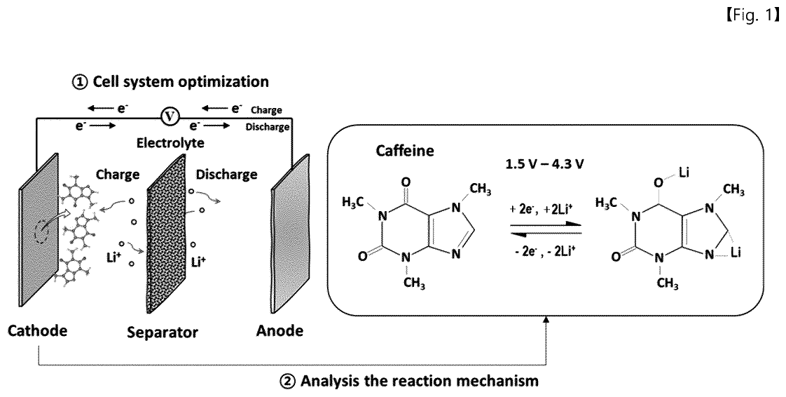

FIG. 1 is a schematic diagram showing the operating principle of a lithium secondary battery and a positive electrode material for a lithium secondary battery according to an embodiment of the disclosure.

FIGS. 16A, 16B, 16C, 16D, 16E, and 16F are schematic diagrams showing peaks of C, N, and O observed in a caffeine molecule by group during XPS measurement of a lithium secondary battery according to an embodiment of the disclosure.

Referring to FIG. 1 and FIGS. 16A, 16B, 16C, 16D, 16E, and 16F, an example of the embodiment is explained.

Referring to FIG. 1, it is possible to confirm that the positive electrode (cathode) constituting the battery includes a caffeine organic material (1,3,7-trimethylpurine-2,6-dione).

At this time, although the positive electrode has an amorphous phase thin film structure, the caffeine organic material (1,3,7-trimethylpurine-2,6-dione) molecule is well maintained, as will be described later in an experimental example.

As shown in the reversible chemical reaction formula shown in FIG. 1, lithium ions may express reversible energy capacity through a reversible reaction in which they form and separate C6—O—Li and N3—Li—C8 bonds with the caffeine organic material.

At this time, the C6—O—Li and N3—Li—C8 bonds may be identified more easily and intuitively by confirming the positions of C6,N3, and C8 with reference to FIGS. 16A, 16B, 16C, 16D, 16E, and 16F.

Previously, carbon nanosheets obtained from coffee grounds were used as positive electrode materials for sodium ion batteries, but there is a technical difference in that, as in the an example of the embodiment, caffeine molecules, which are organic materials, are not utilized as positive electrode materials for lithium secondary batteries. In addition, the above-mentioned conventional technology has a process of heating coffee grounds, and through the above-mentioned heating process, only carbon remains, and there is also a difference in that, as in the embodiment, the organic molecules of the caffeine component are not utilized as active sites.

As an example of the embodiment, there may be a positive electrode material for a lithium secondary battery, characterized in that the amorphous thin film structure has a thickness of 30 μm to 36 μm.

Depending on the thickness range of the above-mentioned thin film, the electrochemical performance of a lithium secondary battery to which the positive electrode for the lithium secondary battery is applied varies, which will be described later in the following experimental examples.

A lithium secondary battery according to another embodiment of the disclosure will be described.

As an example of the embodiment, there may be a lithium secondary battery including: a positive electrode; a negative electrode; and an ion exchange membrane positioned between the positive electrode and the negative electrode, wherein the positive electrode includes the above-described positive electrode material for a lithium secondary battery.

A method for producing a positive electrode material for a lithium secondary battery according to another embodiment of the disclosure is described.

As an example of the embodiment, there may be a method for producing a positive electrode material for a lithium secondary battery, characterized by including: forming a slurry by mixing a caffeine organic material, a conductive material, and a polymer binder with a solvent; coating the formed slurry on a substrate; drying the substrate coated with the slurry in a vacuum to form a film; and forming a thin film by pressing the formed film.

As an example of the embodiment, the forming of the slurry may include: ball-milling a mixture including the caffeine organic material and the conductive material to make the mixture amorphous; and mixing the amorphous mixture with the polymer binder and the solvent.

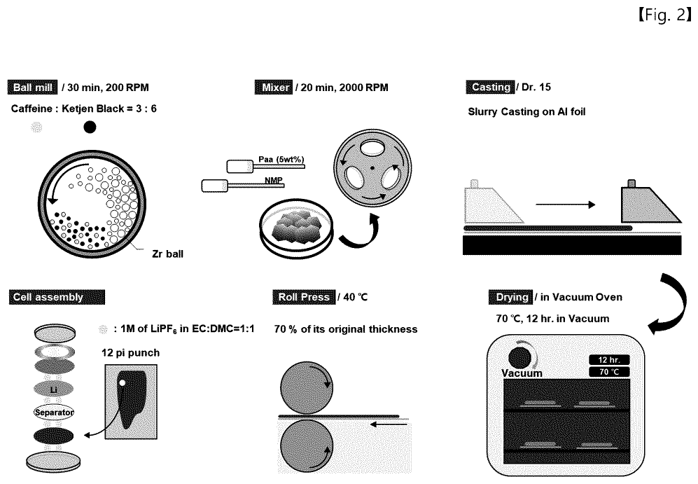

FIG. 2 is a schematic diagram showing the positive electrode material for a lithium secondary battery and the production process of a lithium secondary battery according to an embodiment of the disclosure.

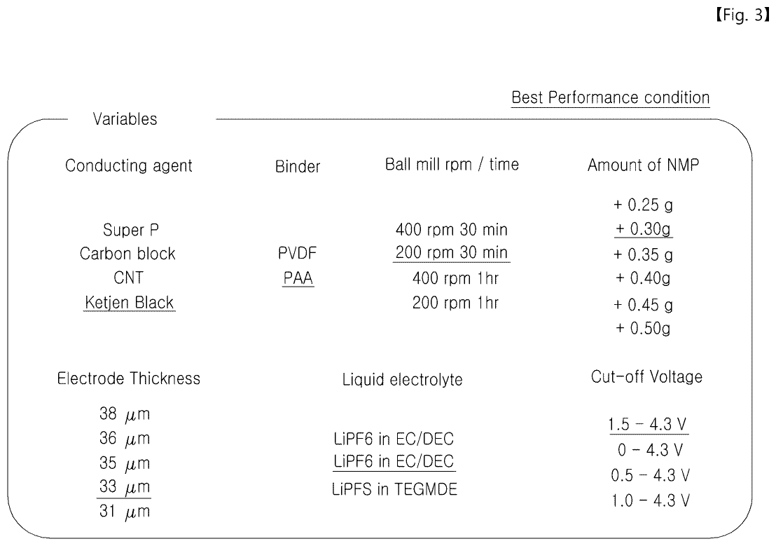

FIG. 3 is a table showing electrode production and battery assembly conditions for implementing optimal performance as a lithium secondary battery according to an embodiment of the disclosure.

Referring to FIGS. 2 and 3, an example of the embodiment is described.

Referring to FIG. 2, first, it is possible to confirm a process of ball milling caffeine organic material (having crystallinity) and Ketjen Black, an example of the conductive material, together to make them amorphous, and then, it is possible to confirm a step of forming a slurry by mixing Paa, a polymer binder, with NMP, a solvent. Thereafter, the generated slurry is coated on a substrate, Al foil, the substrate coated with the slurry is dried in a vacuum oven to form a film, and the formed film is roll pressed, and the thickness of the film is formed thinner to produce the positive electrode or positive electrode material for a lithium secondary battery. In addition, it is possible to confirm the process of producing a lithium secondary battery by combining with other components such as a negative electrode, an exchange membrane, etc.

Referring to FIG. 3, it is possible to confirm the electrode production and battery assembly conditions for implementing optimal performance of a lithium secondary battery that applies a caffeine organic material, which is an example of the embodiment, as a positive electrode material of a lithium secondary battery, such as the amount of the conductive material, polymer binder, and solvent.

As an example of the embodiment, there may be a method for producing a positive electrode material for a lithium secondary battery characterized in that ball milling of the mixture to make the mixture amorphous is performed at 200 rpm to 400 rpm for 30 to 60 minutes.

As an example of the embodiment, there may be a method for producing a positive electrode material for a lithium secondary battery characterized in that the conductive material is at least one selected from the group consisting of Super P, Carbon black, CNT, and Ketjen Black.

More preferably, as an example of the embodiment, there may be a method for producing a positive electrode material for a lithium secondary battery, characterized in that the conductive material is Ketjen Black.

As an example of the embodiment, there may be a method for producing a positive electrode material for a lithium secondary battery, characterized in that the polymer binder is at least one selected from PVDF and PAA.

More preferably, as an example of the embodiment, there may be a method for producing a positive electrode material for a lithium secondary battery, characterized in that the polymer binder is PAA.

As an example of the embodiment, there may be a method for producing a positive electrode material for a lithium secondary battery, characterized in that the solvent is N-methylpyrrolidone.

As an example of the embodiment, there may be a method for producing a positive electrode material for a lithium secondary battery, characterized in that the amount of the solvent is 0.25 g to 0.4 g.

More preferably, as an example of the embodiment, there may be a method for producing a positive electrode material for a lithium secondary battery, characterized in that the amount of the solvent is 0.3 g to 0.35 g.

As an example of the embodiment, there may be a method for producing a positive electrode material for a lithium secondary battery, characterized in that in the step of forming the slurry, the mixing ratio of the caffeine organic material, the conductive material, and the polymer binder are mixed in a weight ratio of 3:6:1 to 6:3:1.

More preferably, as an example of the embodiment, there may be a method for producing a positive electrode material for a lithium secondary battery, characterized in that in the forming of the slurry, the mixing ratio of the caffeine organic material, the conductive material, and the polymer binder corresponds to a weight ratio of 3:6:1 to 4:5:1.

More preferably, as an example of the embodiment, in the forming of the slurry, there may be a method for producing a positive electrode material for a lithium secondary battery, characterized in that the mixing ratio of the caffeine organic material, the conductive material, and the polymer binder corresponds to a weight ratio of 4:5:1.

As an example of the embodiment, there may be a method for producing a positive electrode material for a lithium secondary battery, characterized in that in the coating, the substrate is aluminum foil.

As an example of the embodiment, there may be a method for producing a positive electrode material for a lithium secondary battery, characterized in that the forming of the film by drying in the vacuum is performed at a temperature range of 60° C. to 80° C. for 10 to 15 hours.

As an example of the embodiment, there may be a method for producing a positive electrode material for a lithium secondary battery, characterized in that in the forming of the thin film by pressing, the thickness of the thin film is 30 μm to 36 μm.

More preferably, as an example of the embodiment, there may be a method for producing a positive electrode material for a lithium secondary battery, characterized in that the forming of the thin film by pressing is such that the thickness of the thin film is 33 μm to 35 μm.

More preferably, as an example of the embodiment, there may be a method for producing a positive electrode material for a lithium secondary battery, characterized in that the forming of the thin film by pressing is such that the thickness of the thin film is 33 μm.

### Production Example 1. A Positive Electrode Material for a Lithium Secondary Battery According to an Embodiment of the Disclosure.

Referring to FIG. 2, the production example 1 is explained.
1. ball milling the crystalline caffeine organic material (1,3,7-trimethylpurine-2,6-dione) and Ketjen Black together to make them amorphous (30 min, 200 RPM)
2. adding and mixing Paa and a solvent (NMP) to form a slurry (20 min, 2000 RPM)
3. casting the formed slurry on Al foil and drying the same
4. drying the Al foil coated with the slurry in a vacuum oven to form a film (70° C., 12 hr)
5. pressing the formed film to form a thin film with a thickness of 33 μm

Through the steps, the positive electrode material for a lithium secondary battery may be produced.

### Production Example 2. A Lithium Secondary Battery According to an Embodiment of the Disclosure

producing the positive electrode material through the process of production example 1
additionally, combining the same with other components such as a negative electrode and an exchange membrane

Through the steps, a lithium secondary battery may be finally produced.

### Experimental Example 1. Evaluation of Electrochemical Characteristics of Lithium Secondary Battery According to Each Condition

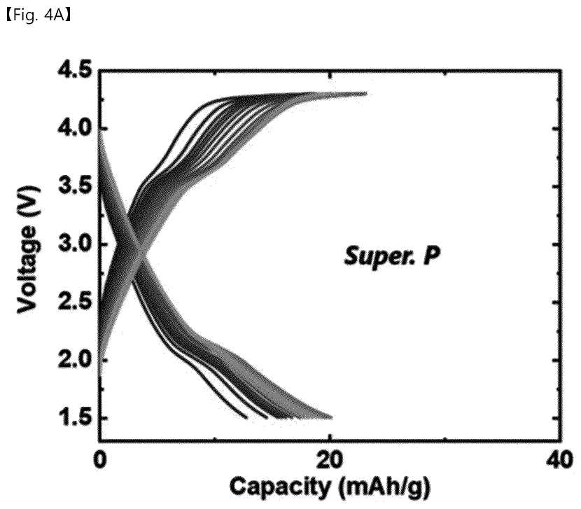

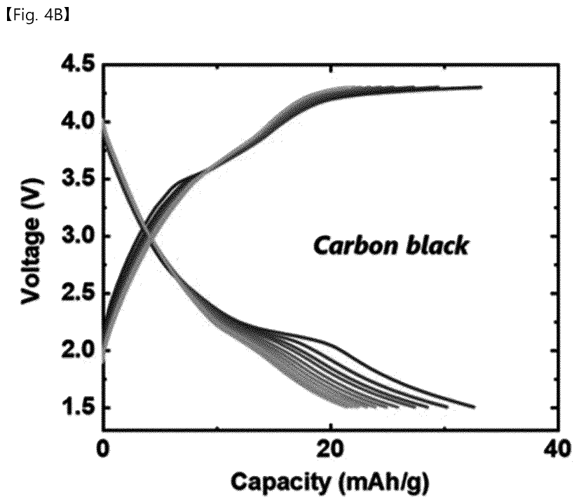

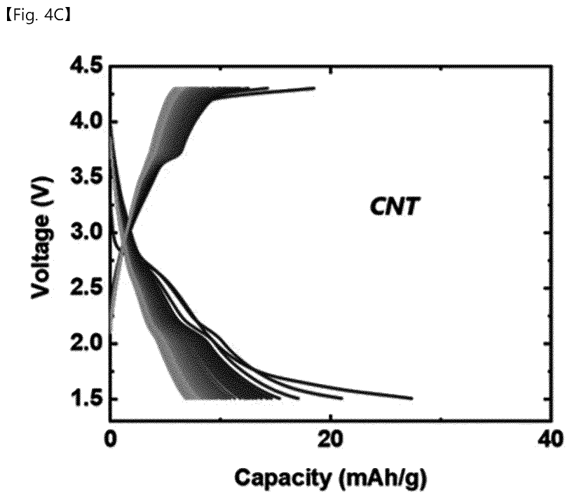

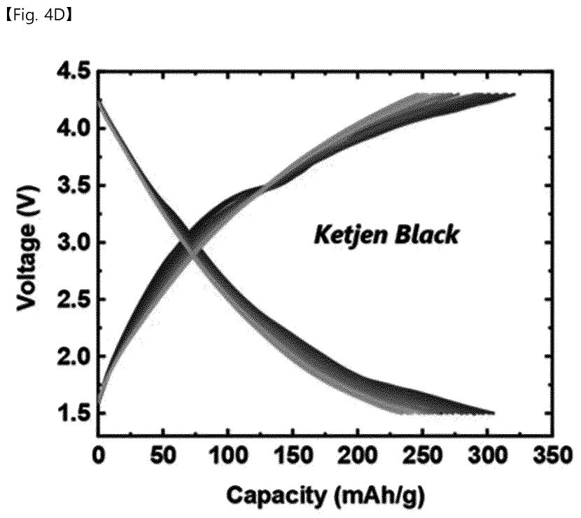

FIGS. 4A, 4B, 4C, and 4D are each a graph showing the results of an electrochemical characteristic evaluation according to the type of conductive material used in the production process of a lithium secondary battery according to an embodiment of the disclosure.

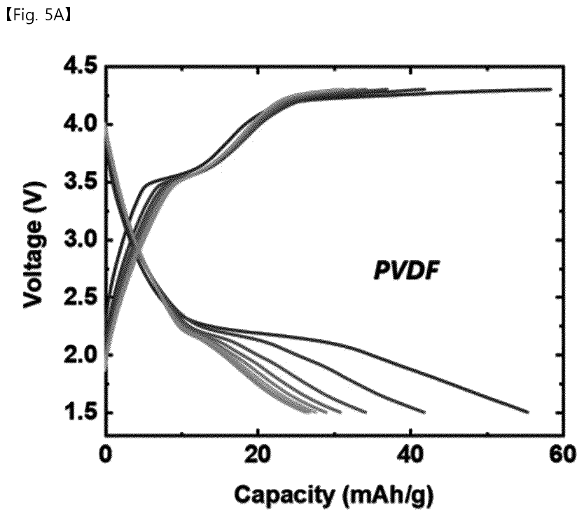

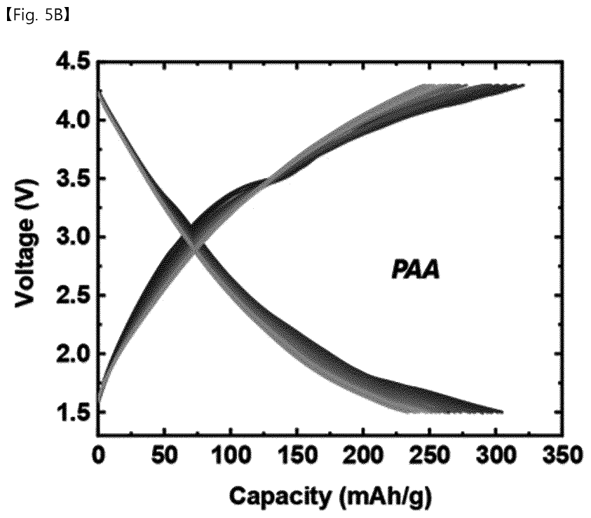

FIGS. 5A and 5B are each a graph showing the results of an electrochemical characteristic evaluation according to the type of polymer binder used in the production process of a lithium secondary battery according to an embodiment of the disclosure.

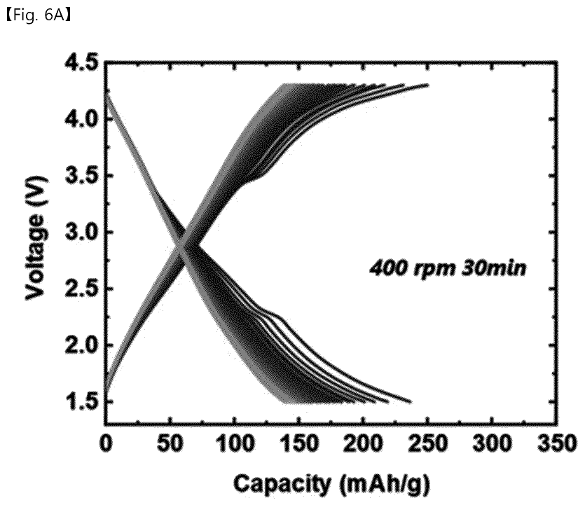

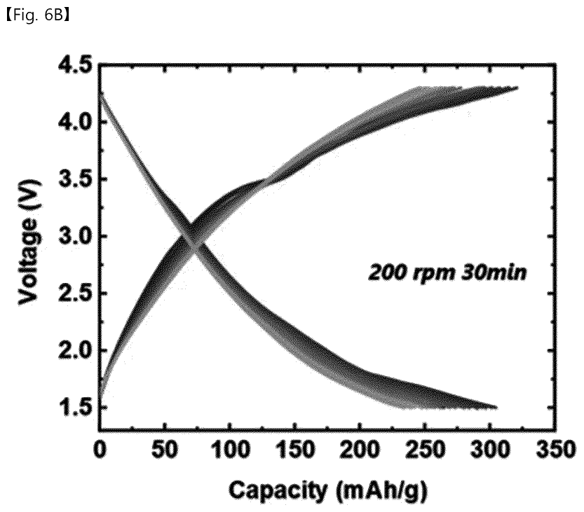

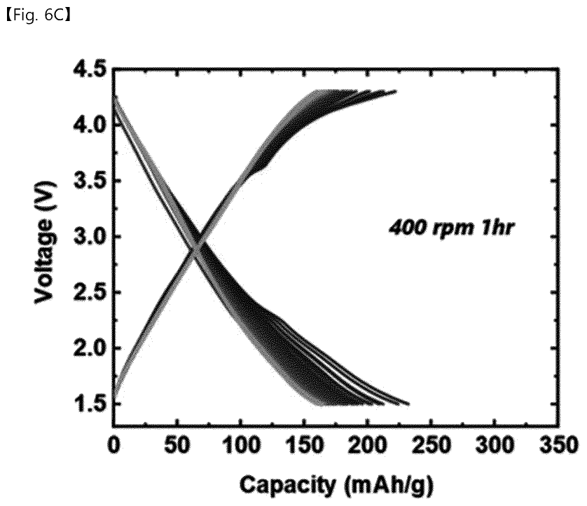

FIGS. 6A, 6B, 6C, and 6D are each a graph showing the results of an electrochemical characteristic evaluation according to the conditions of a step of ball milling a mixture to make the mixture amorphous during the production process of a lithium secondary battery according to an embodiment of the disclosure.

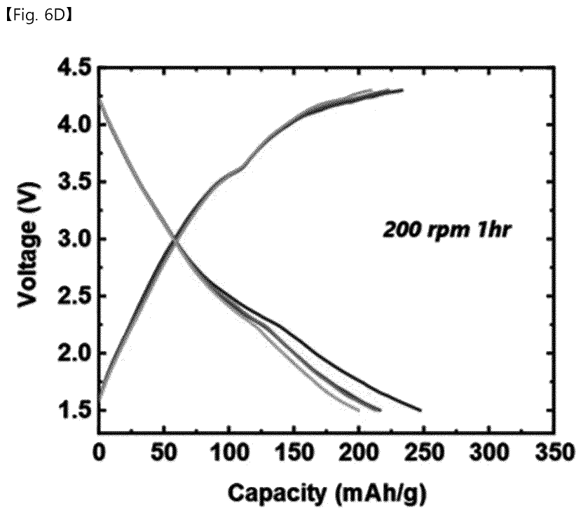

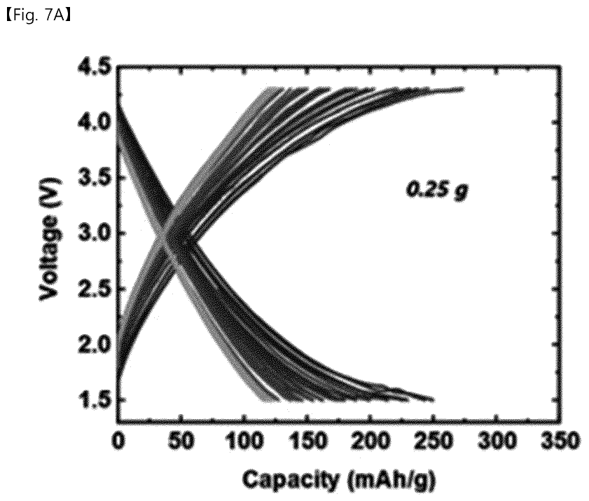

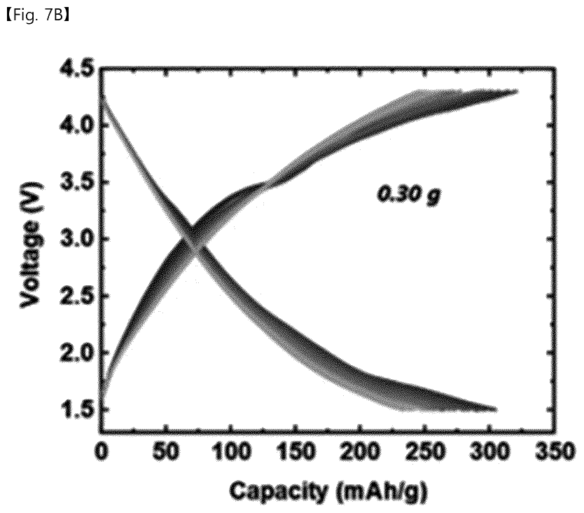

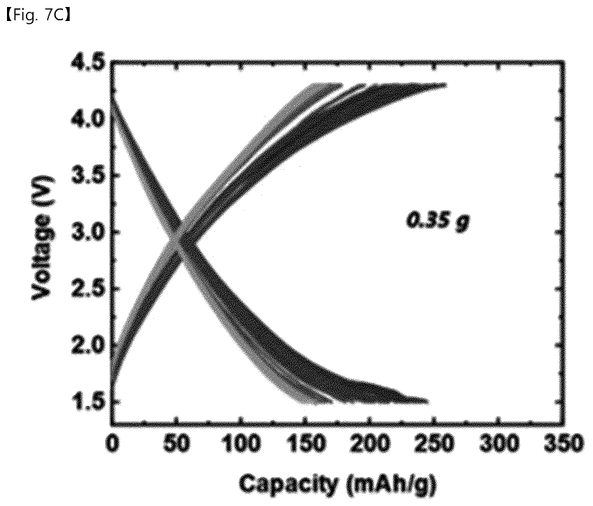

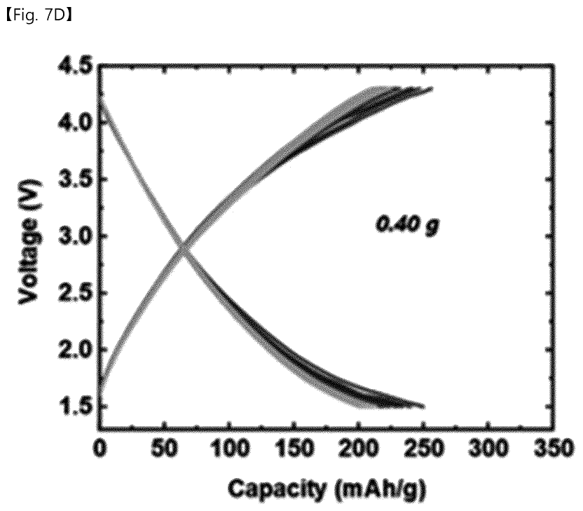

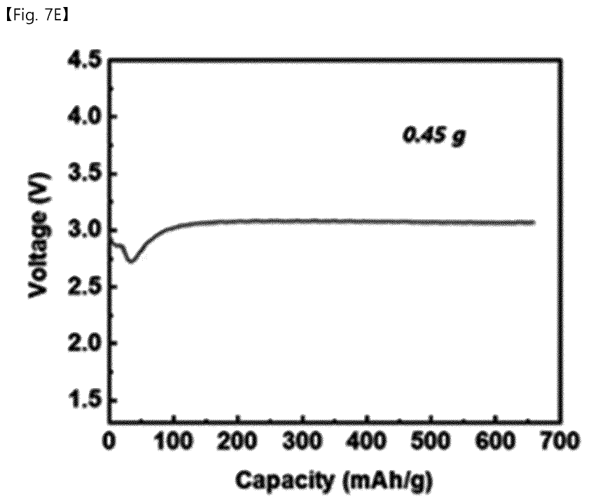

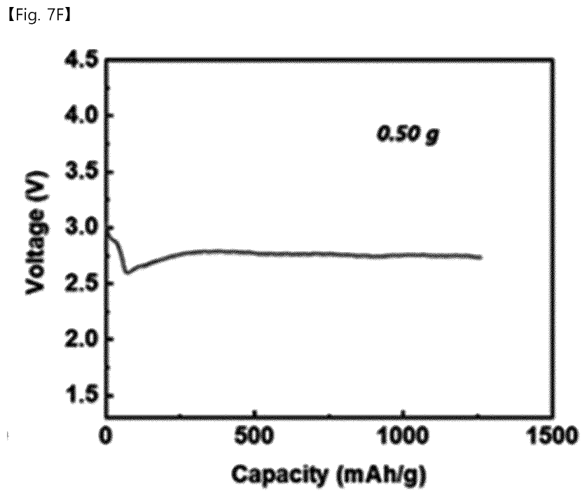

FIGS. 7A, 7B, 7C, 7D, 7E, and 7F are each a graph showing the results of an electrochemical characteristic evaluation according to the amount of solvent used in the production process of a lithium secondary battery according to an embodiment of the disclosure.

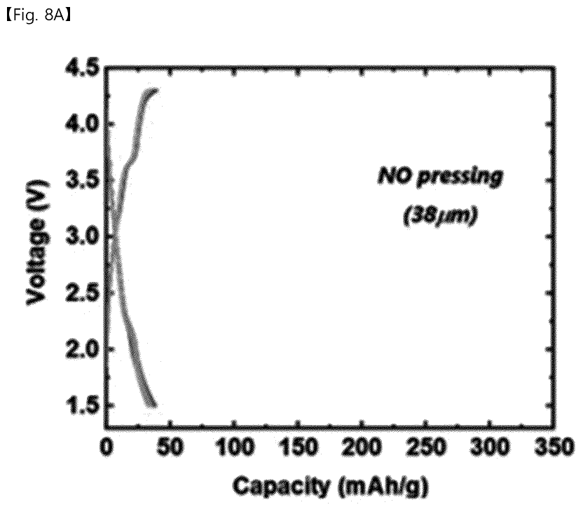

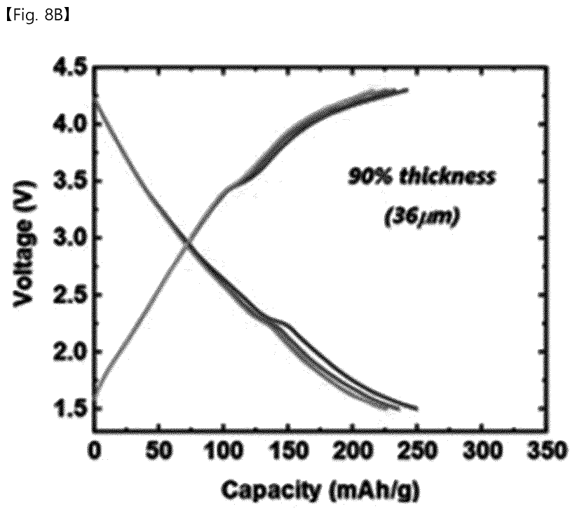

FIGS. 8A, 8B, 8C, 8D, and 8E are each a graph showing the results of an electrochemical characteristic evaluation according to the thin film thickness of a positive electrode material for a lithium secondary battery applied to a lithium secondary battery according to an embodiment of the disclosure.

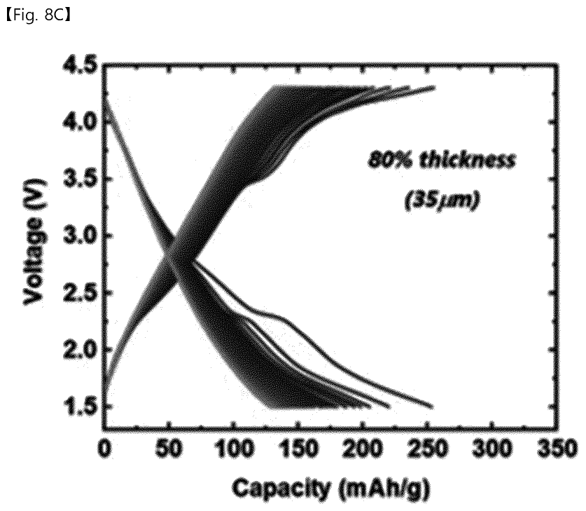

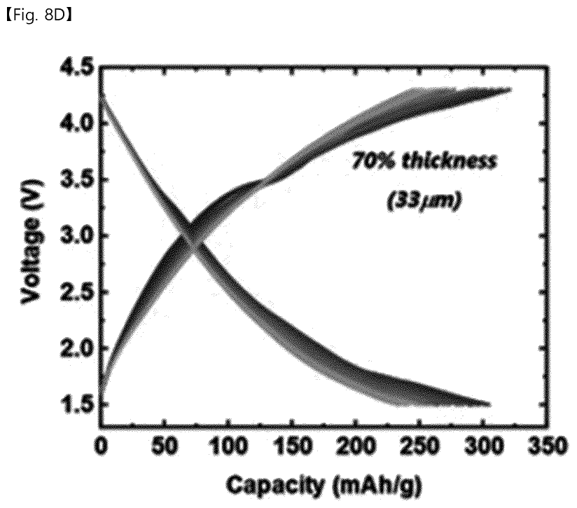

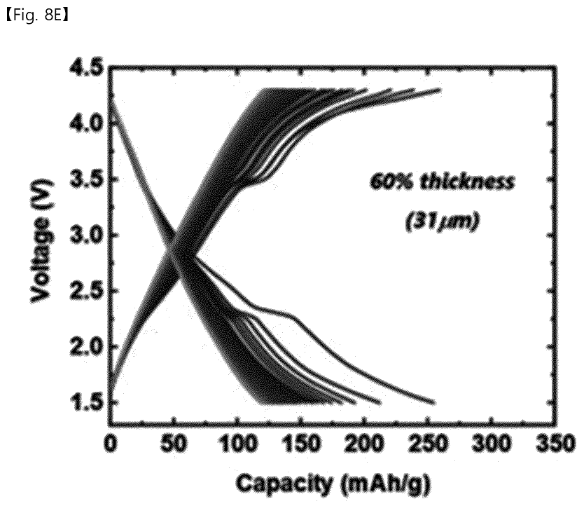

FIGS. 9A, 9B, and 9C are each a graph showing the results of an electrochemical characteristic evaluation according to the type of electrolyte used in the production process of a lithium secondary battery according to an embodiment of the disclosure.

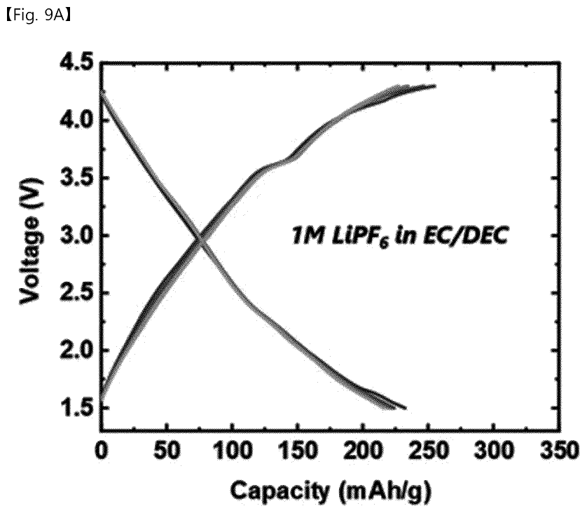

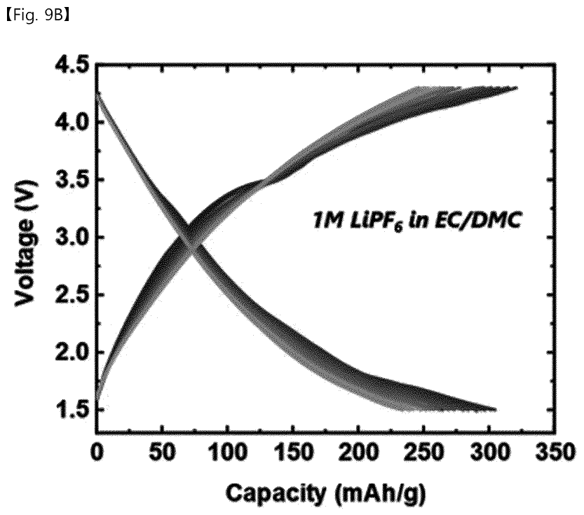

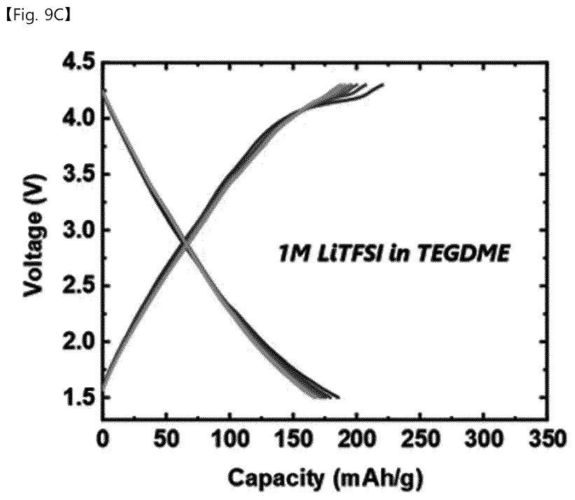

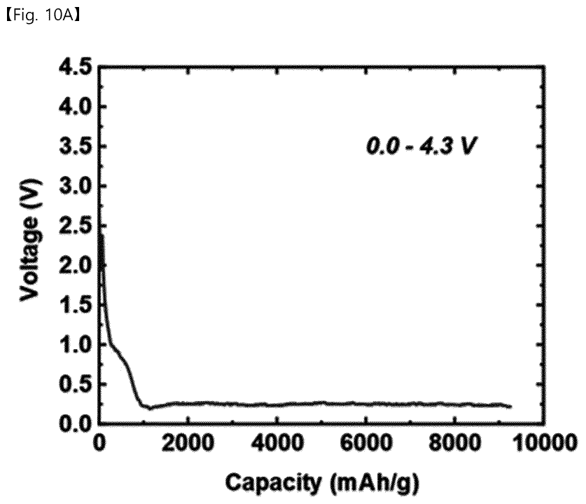

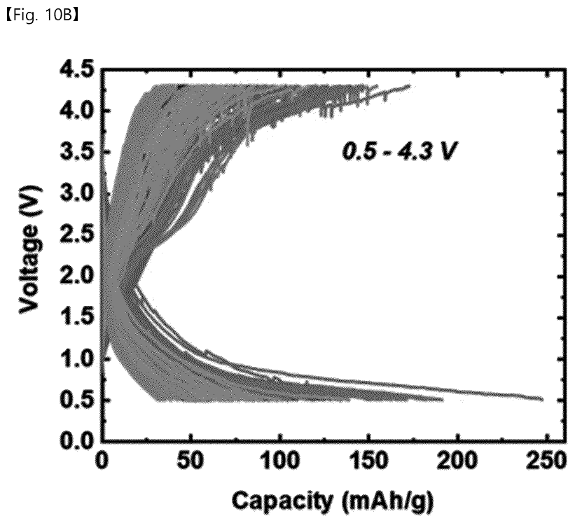

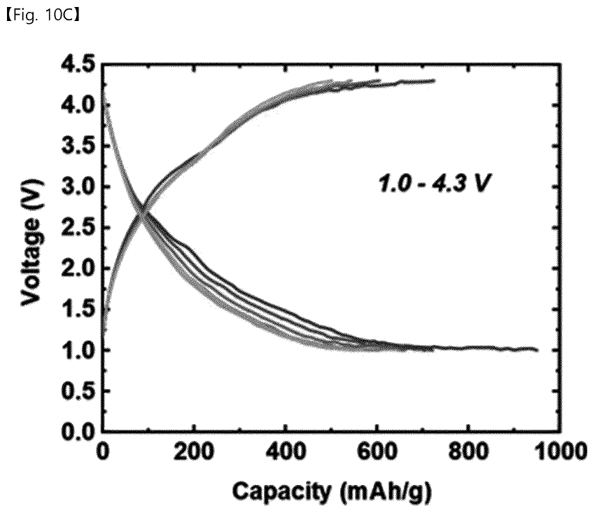

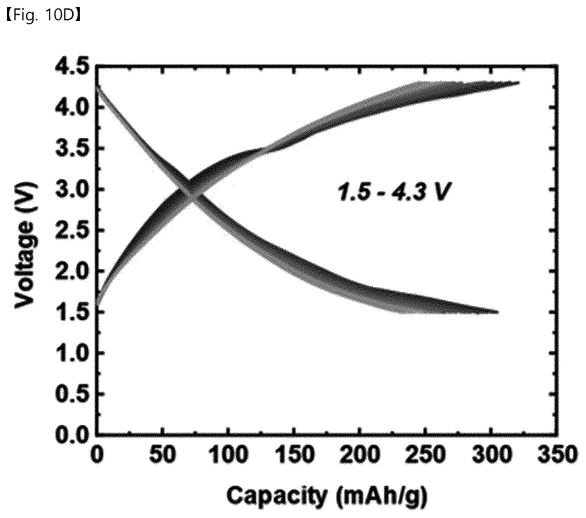

FIGS. 10A, 10B, 10C, and 10D are each a graph showing the results of an electrochemical characteristic evaluation according to the voltage range of charge and discharge of a lithium secondary battery according to an embodiment of the disclosure.

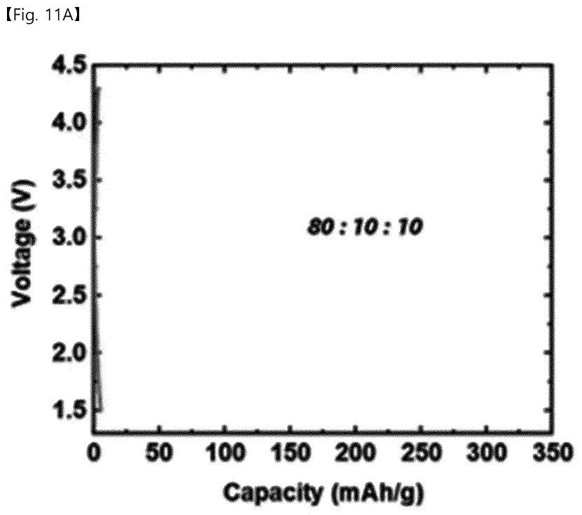

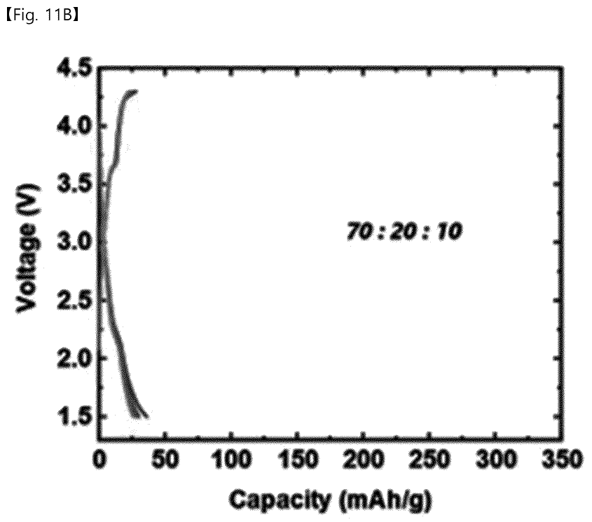

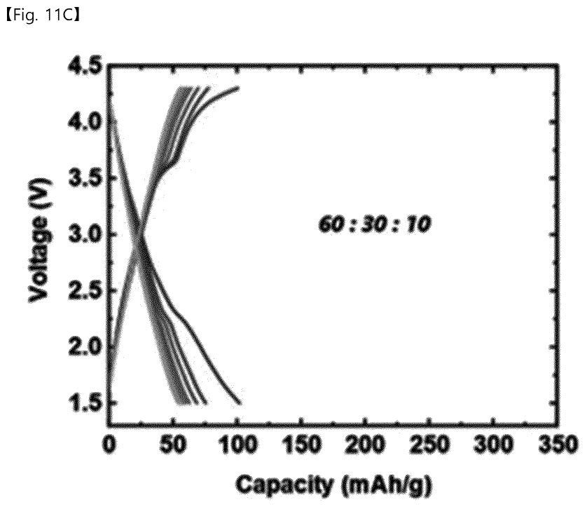

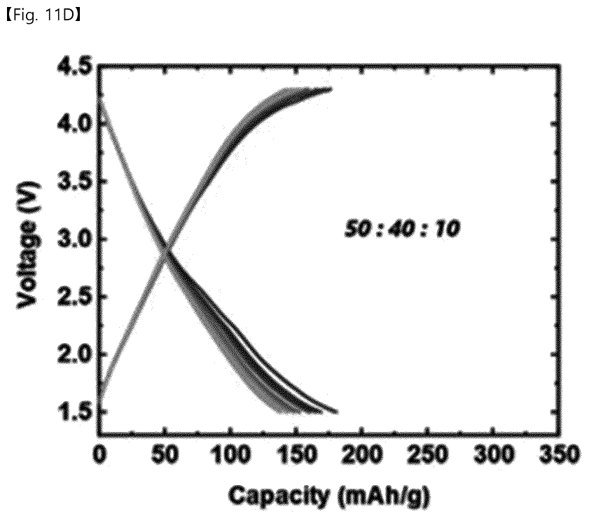

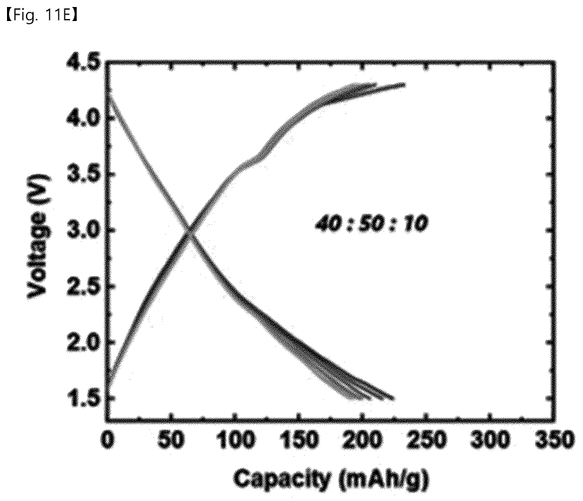

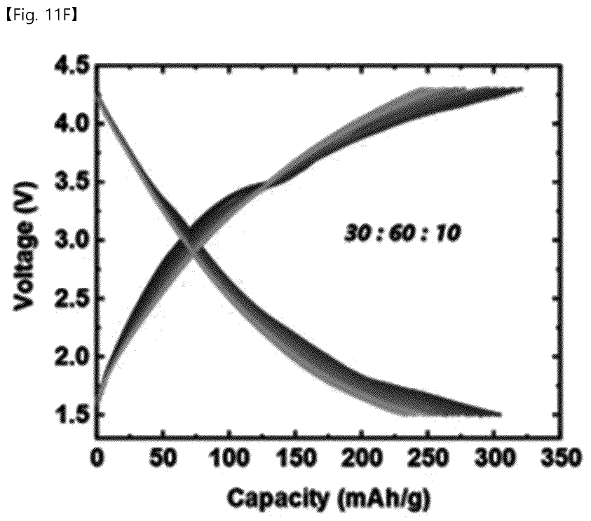

FIGS. 11A, 11B, 11C, 11D, 11E, and 11F are each a graph showing the results of evaluating the electrochemical characteristics according to the voltage range of charge and discharge of a lithium secondary battery according to the mixing ratio of a caffeine organic material, conductive material, and polymer binder used in the production process of a lithium secondary battery according to an embodiment of the disclosure.

Referring to FIGS. 4A, 4B, 4C, and 4D to FIGS. 11A, 11B, 11C, 11D, 11E, and 11F, experimental example 1 is described.

### 1. Conductive Material

In order to select the optimal conductive material used when producing electrodes, the positive electrode active material, the conductive material, and the binder were mixed in a weight ratio of 30:60:10, and N-methylpyrrolidone (NMP) was used as a solvent to produce a slurry.

Thereafter, the slurry was coated on aluminum foil, dried, and then dried at 70° C. for 12 hours in a vacuum to produce an electrode.

A total of four conductive materials, Super P, Carbon Black, CNT, and Ketjen Black, were used to produce the electrode.

At this time, the following conditions were fixed.
Binder: PAA
Ball mill rpm/time: 200 rpm/30 min
NMP amount: 0.30 g
Electrode thickness: 70% of original thickness (33 μm)
Electrolyte type: LiPF6 in EC/DMC
Battery operating voltage range: 1.5-4.3 V

Each electrode using the conductive material was used, and
the electrolyte was a solution containing 1 mol of LiPF6 dissolved in a solvent containing 1:1 of ethylene carbonate (EC) and dimethyl carbonate (DMC), and a typical coin cell was produced.

For the battery produced as above, the voltage range of charge and discharge at room temperature (25° C.) was 1.5-4.3 vs. Li/Li⁺, and the charge-discharge evaluation was performed at 0.1 C/0.1 C. (1.0 C=276 mAh/g)

Referring to FIGS. 4A, 4B, 4C, and 4D, it is possible to see that Ketjen Black exhibits the best electrochemical performance.

### 2. Binder

In order to select an optimal binder used in producing electrodes, the positive electrode active material, conductive material, and binder were mixed in a weight ratio of 30:60:10, and a slurry was produced using N-methylpyrrolidone (NMP) as a solvent.

Thereafter, the slurry was coated on aluminum foil, dried, and then dried at 70° C. for 12 hours in a vacuum to produce electrodes.

Two types of binders, polyvinylidene fluoride (PDVF) and polyacrylic acid (PAA) were used to produce electrodes.

At this time, the following conditions were fixed.
Conductive material: Ketjen Black
Ball mill rpm/time: 200 rpm/30 min
NMP amount: 0.30 g
Electrode thickness: 70% of original thickness (33 μm)
Electrolyte type: LiPF6 in EC/DMC
Battery operating voltage range: 1.5-4.3 V

Each electrode using the binder was used, and a solution containing 1 mol of LiPF6 dissolved in a 1:1 mixture of ethylene carbonate (EC) and dimethyl carbonate (DMC) was used as the electrolyte to produce a typical coin cell.

For the battery produced as above, the voltage range of charge and discharge at room temperature (25° C.) was 1.5-4.3 vs. Li/Li⁺, and the charge-discharge evaluation was performed at 0.1 C/0.1 C. (1.0 C=276 mAh/g)

Referring to FIGS. 5A and 5B, it is possible to confirm that PAA shows the best electrochemical performance.

### 3. Ball Mill Time and RPM

In order to select the optimal ball mill time and RPM used when producing electrodes, the positive electrode active material, conductive material, and binder were mixed in a weight ratio of 30:60:10, and a slurry was produced using N-methylpyrrolidone (NMP) as a solvent.

Thereafter, the slurry was coated on aluminum foil, dried, and then dried at 70° C. for 12 hours in a vacuum to produce an electrode.

The ball mill time and RPM were 400 rpm/30 minutes, 200 rpm/30 minutes, 400 rpm/1 hour, and 200 rpm/1 hour, respectively, and a total of four conditions were used to produce electrodes.

At this time, the following conditions were fixed.
Conductive material: Ketjen Black
Binder: PAA
NMP amount: 0.30 g
Electrode thickness: 70% of original thickness (33 μm)
Electrolyte type: LiPF6 in EC/DMC
Battery operating voltage range: 1.5-4.3 V

Each electrode utilizing the ball mill conditions was used, and a solution containing 1 mol of LiPF6 dissolved in a 1:1 mixture of ethylene carbonate (EC) and dimethyl carbonate (DMC) was used as the electrolyte to produce a typical coin cell.

For the battery produced as above, the voltage range of charge and discharge at room temperature (25° C.) was 1.5-4.3 vs. Li/Li⁺, and the charge-discharge evaluation was performed at 0.1 C/0.1 C. (1.0 C=276 mAh/g)

Referring to FIGS. 6A, 6B, 6C, and 6D, it is possible to confirm that the condition of 200 rpm/30 min shows the best electrochemical performance.

### 4. Amount of Solvent (N-methylpyrrolidone)

In order to select the optimal amount of N-methylpyrrolidone (NMP) used in producing electrodes, the positive electrode active material, conductive material, and binder were mixed in a weight ratio of 30:60:10, and a slurry was produced using N-methylpyrrolidone (NMP) as a solvent.

Thereafter, the slurry was coated on aluminum foil, dried, and then dried at 70° C. for 12 hours in a vacuum to produce electrodes.

The amounts of NMP used were 0.25 g, 0.30 g, 0.35 g, 0.40 g, 0.45 g, and 0.50 g, respectively, and a total of six conditions were used to produce electrodes.

At this time, the following conditions were fixed.
Conductive material: Ketjen Black
Binder: PAA
Ball mill rpm/time: 200 rpm/30 min
Electrode thickness: 70% of original thickness (33 μm)
Electrolyte type: LiPF6 in EC/DMC
Battery operating voltage range: 1.5-4.3 V

Each electrode utilizing the NMP conditions was used, and a solution containing 1 mol of LiPF6 dissolved in a 1:1 mixture of ethylene carbonate (EC) and dimethyl carbonate (DMC) was used as the electrolyte to produce a typical coin cell.

For the battery produced as above, the voltage range of charge and discharge at room temperature (25° C.) was 1.5-4.3 vs. Li/Li⁺, and the charge-discharge evaluation was performed at 0.1 C/0.1 C. (1.0 C=276 mAh/g)

Referring to FIGS. 7A, 7B, 7C, 7D, 7E, and 7F, it is possible to confirm that the condition of 0.3 g shows the best electrochemical performance.

### 5. Thickness of Electrode Thin Film

In order to select the optimal electrode thickness used when producing electrodes, the positive electrode active material, conductive material, and binder were mixed in a weight ratio of 30:60:10, and a slurry was produced using N-methylpyrrolidone (NMP) as a solvent.

Thereafter, the slurry was coated on aluminum foil, dried, and then dried at 70° C. for 12 hours in a vacuum to produce electrodes.

The target electrode thickness was set to 38 μm, 36 μm, 35 μm, 33 μm, and 31 μm, respectively, and electrodes were produced with a total of five electrode thicknesses.

At this time, the following conditions were fixed.
Conductive material: Ketjen Black
Binder: PAA
Ball mill rpm/time: 200 rpm/30 min
NMP amount: 0.30 g
Electrolyte type: LiPF6 in EC/DMC
Battery operating voltage range: 1.5-4.3 V

Each electrode utilizing the electrode thickness conditions was used, and a solution containing 1 mol of LiPF6 dissolved in a 1:1 mixture of ethylene carbonate (EC) and dimethyl carbonate (DMC) was used as an electrolyte to produce a typical coin cell.

For the battery produced as above, the voltage range of charge and discharge at room temperature (25° C.) was 1.5-4.3 vs. Li/Li⁺, and the charge-discharge evaluation was performed at 0.1 C/0.1 C. (1.0 C=276 mAh/g)

Referring to FIGS. 8A, 8B, 8C, 8D, and 8E, it is possible to confirm that the condition of 33 μm shows the best electrochemical performance.

### 6. Type of Electrolyte

In order to select the optimal electrolyte used in the cell evaluation, the positive electrode active material, conductive material, and binder were mixed in a weight ratio of 30:60:10, and N-methylpyrrolidone (NMP) was used as a solvent to produce a slurry.

Thereafter, the slurry was coated on aluminum foil, dried, and then dried at 70° C. for 12 hours in a vacuum to produce electrodes.

The electrolytes used were, respectively,
1M LiPF6 in EC/DEC, a solution containing 1 mol of LiPF6 dissolved in a 1:1 mixture of ethylene carbonate (EC) and diethyl carbonate (DEC),
1M LiPF6 in EC/DMC, a solution containing 1 mol of LiPF6 dissolved in a 1:1 mixture of ethylene carbonate (EC) and dimethyl carbonate (DMC), and
1M LiTFSI in TEGDME, a solution containing 1 mol of LiTFSI dissolved in TEGDME (Tetraethylene glycol dimethyl ether), wherein
a total of the three electrolytes were used for electrochemical evaluation.

At this time, the following conditions were fixed.
Conductive material: Ketjen Black
Binder: PAA
Ball mill rpm/time: 200 rpm/30 min
NMP amount: 0.30 g
Electrode thickness: 70% of original thickness (33 μm)
Battery operating voltage range: 1.5-4.3 V

Each electrode using the electrode conditions was used, and each electrolyte was used to produce a typical coin cell.

For the battery produced as above, the voltage range of charge and discharge at room temperature (25° C.) was 1.5-4.3 vs. Li/Li⁺, and the charge-discharge evaluation was performed at 0.1 C/0.1 C. (1.0 C=276 mAh/g)

Referring to FIGS. 9A, 9B, and 9C, it is possible to confirm that the condition of 1M LiPF6 in EC/DMC electrolyte shows the best electrochemical performance.

### 7. Voltage Range

To select the optimal voltage range used in cell evaluation, the positive electrode active material, conductive material, and binder were mixed in a weight ratio of 30:60:10, and N-methylpyrrolidone (NMP) was used as a solvent to produce a slurry.

Thereafter, the slurry was coated on aluminum foil, dried, and then dried at 70° C. for 12 hours in a vacuum to produce electrodes.

The electrochemical evaluation was performed using a total of four voltage ranges: 0.0-4.3 V vs. Li/Li⁺, 0.5-4.3 V vs. Li/Li⁺, 1.0-4.3 V vs. Li/Li⁺, 1.5-4.3 V vs. Li/Li⁺.

At this time, the following conditions were fixed.
Conductive material: Ketjen Black
Binder: PAA
Ball mill rpm/time: 200 rpm/30 min
NMP amount: 0.30 g
Electrode thickness: 70% of original thickness (33 μm)
Electrolyte type: LiPF6 in EC/DMC

Each electrode using the electrode conditions was used, and a typical coin cell was produced.

For the batteries produced as above, the voltage ranges for charging and discharging at room temperature (25° C.) were set to the conditions, and the charge-discharge evaluation was performed at 0.1 C/0.1 C. (1.0 C=276 mAh/g)

Referring to FIGS. 10A, 10B, 10C, and 10D, it is possible to confirm that the condition using the voltage range of 1.5-4.3 V vs. Li/Li⁺ shows the best electrochemical performance.

### 8. The Ratio Between Electrode Components

In order to find the optimal ratio between the electrode components when producing electrodes, the positive electrode active material, the conductive agent, and the binder were each mixed in a weight ratio of (80:10:10), (70:20:10), (60: 30: 10), (50:40:10), (40:50:10), and (30:60:10), and a slurry was produced using N-methylpyrrolidone (NMP) as a solvent.

Thereafter, the slurry was coated on aluminum foil, dried, and then dried at 70° C. for 12 hours in a vacuum to produce an electrode.

At this time, the following conditions were fixed.
Conductive material: Ketjen Black
Binder: PAA
Ball mill rpm/time: 200 rpm/30 min
NMP amount: 0.30 g
Electrode thickness: 70% of original thickness (33 μm)
Electrolyte type: LiPF6 in EC/DMC
Battery operating voltage range: 1.5-4.3 V

Each of the electrodes was used, and a solution containing 1 mol of LiPF6dissolved in a 1:1 mixture of ethylene carbonate (EC) and dimethyl carbonate (DMC) was used as [symbol] electrolyte to produce a typical coin cell.

For the battery produced as above, the voltage range of charge and discharge at room temperature (25° C.) was 1.5-4.3 vs. Li/Li⁺, and the charge-discharge evaluation was performed at 0.1 C/0.1 C. (1.0 C=276 mAh/g)

Referring to FIGS. 11A, 11B, 11C, 11D, 11E, and 11F, it is possible to confirm that the condition using a weight ratio of active material: conductive material: binder=30:60:10 shows the best electrochemical performance.

### Experimental Example 2. Electrode Structure Analysis

FIGS. 12A and 12B are each a graph showing the results of X-ray diffraction analysis of a positive electrode material for a lithium secondary battery according to an embodiment of the disclosure and schematic diagrams briefly representing the amorphous phase of the positive electrode material.

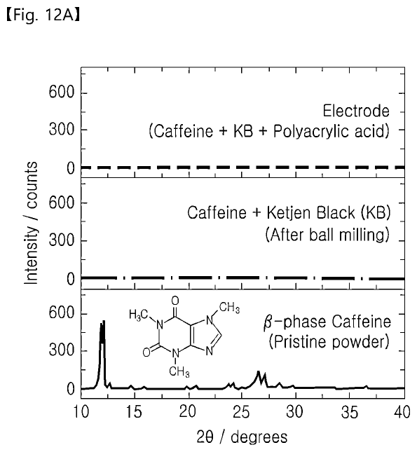

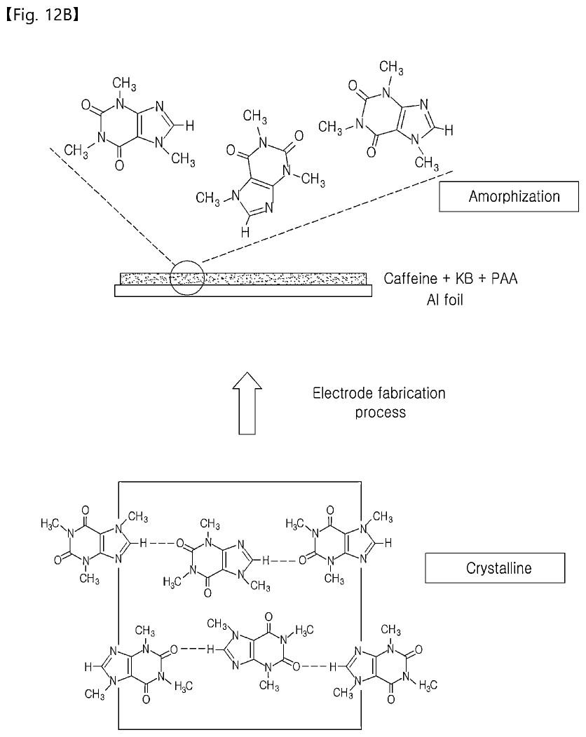

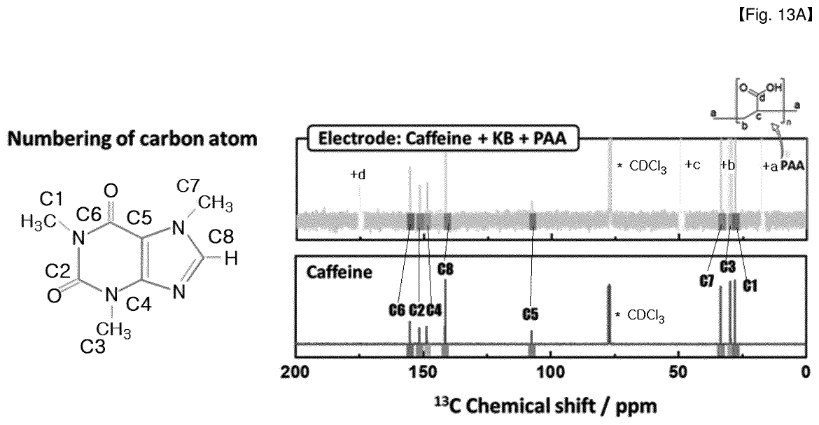

FIG. 13A is a graph showing the results of C-NMR analysis of a positive electrode material for a lithium secondary battery according to an embodiment of the disclosure.

FIG. 13B is a graph showing the results of H-NMR analysis of a positive electrode material for a lithium secondary battery according to an embodiment of the disclosure.

FIGS. 14A and 14B are each a graph showing the results of charge-discharge evaluation of a lithium secondary battery according to an embodiment of the disclosure.

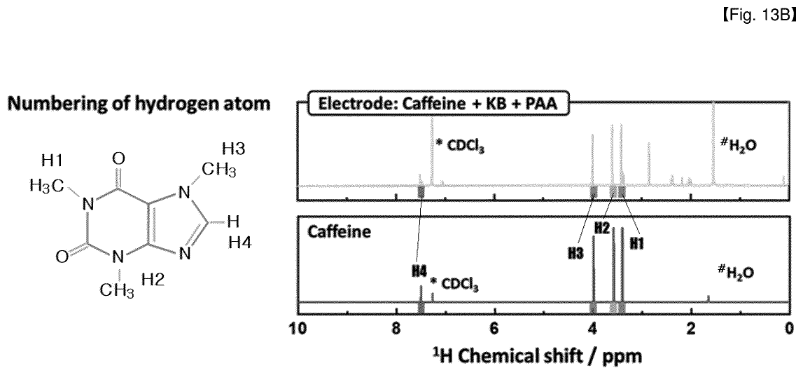

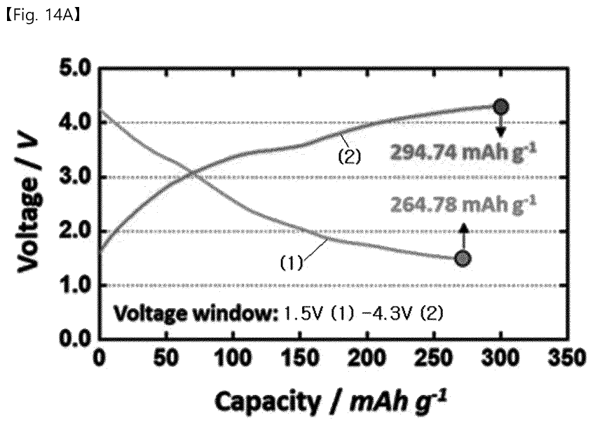

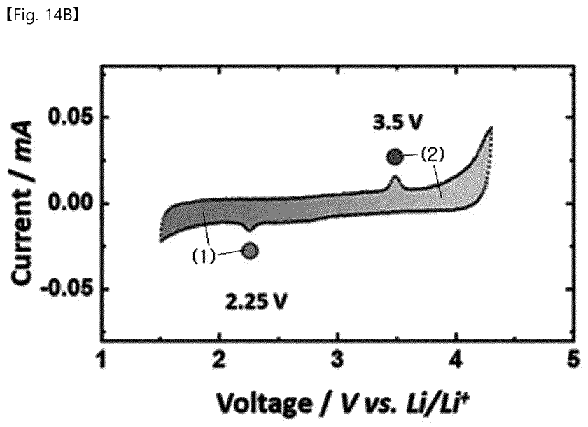

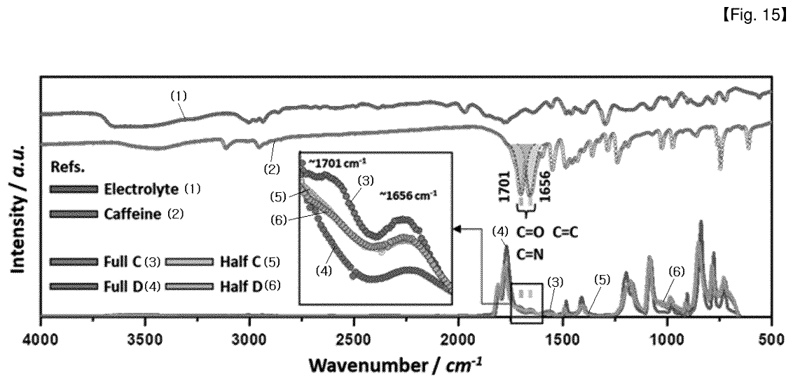

FIG. 15 is a graph showing IR spectra of four state-of-charge states of a lithium secondary battery according to an embodiment of the disclosure.

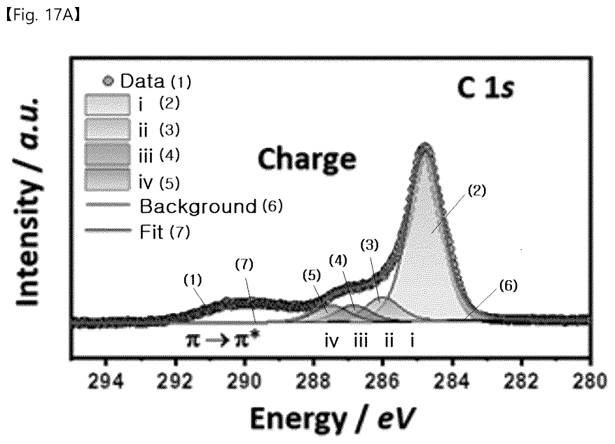

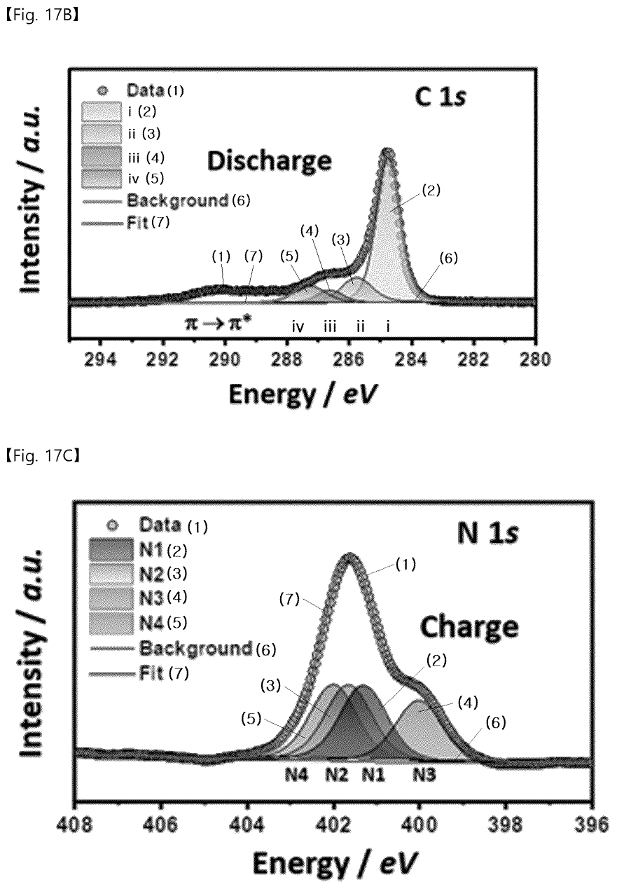

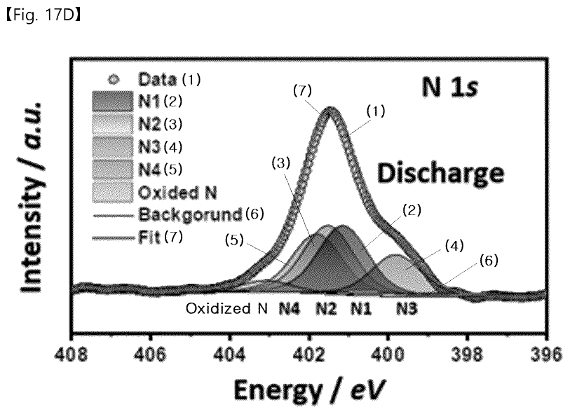

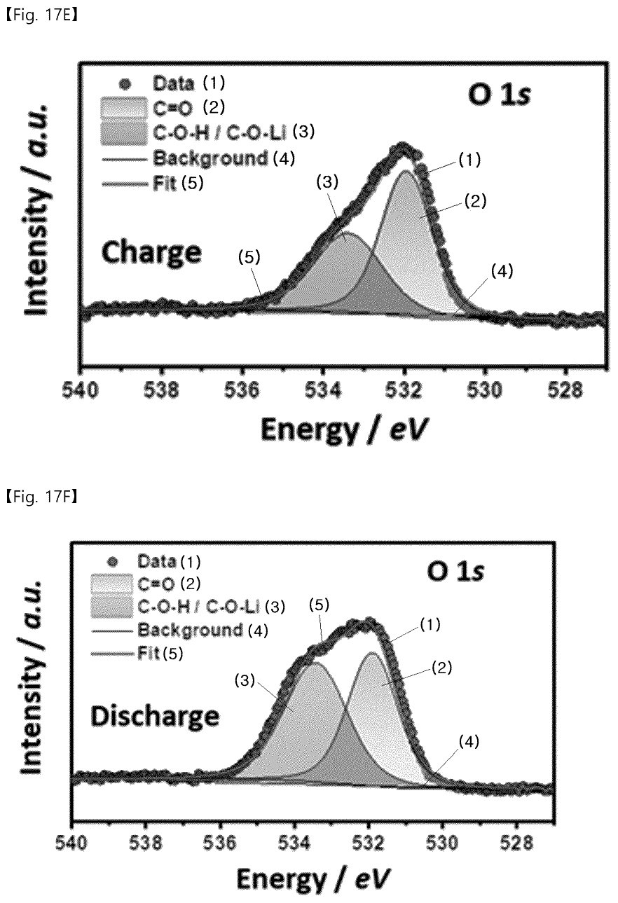

FIGS. 17A, 17B, 17C, 17D, 17E, and 17F are each a graph showing the XPS measurement results of C, N, and O elements in caffeine molecules in the charge and discharge states of a lithium secondary battery according to an embodiment of the disclosure.

Experimental example 2 is described with reference to FIGS. 12A and 12B to FIGS. 17A, 17B, 17C, 17D, 17E, and 17F.

Referring to FIGS. 12A and 12B, the X-ray diffraction analysis results of the electrode produced under the positive electrode production condition of the lithium secondary battery according to an embodiment of the disclosure show that the final electrode has changed into an amorphous phase.

Referring to FIGS. 13A and 13B, the NMR analysis results of the electrode produced under the positive electrode production conditions of a lithium secondary battery according to an embodiment of the disclosure show that the final electrode has changed into an amorphous phase, but the caffeine (1,3,7-trimethylpurine-2,6-dione) molecule is well maintained through NMR.

FIGS. Referring to 14A and 14B, a battery was made based on an electrode made under the positive electrode produce condition of a lithium secondary battery according to an embodiment of the disclosure, the voltage range of charge and discharge was 1.5 to 4.3 V vs. Li/Li⁺ at room temperature (25° C.), the charge-discharge evaluation was performed at 0.1 C/0.1 C (1.0 C=276 mAh/g), and as a result of cyclic voltammetry (CV) at 0.05 mVs-1 and 1.5 to 4.3 V, the initial charge and discharge capacities were 294.74 mAh/g and 264.78 mAh/g, respectively, and two prominent redox peaks could be observed at 3.5 V and 2.23 V in the cyclic voltammetry.

Considering that the theoretical capacity value shown per unit lithium ion is 138 mAh/g, it is possible to confirm that a total of 2 lithium ion react.

Referring to FIG. 15, it is possible to confirm the results of the IR spectra (1.0 C=276 mAh/g) of the 4 state-of-charge states obtained as a battery made based on an electrode made under the positive electrode produce condition of a lithium secondary battery according to an embodiment of the disclosure was performed at room temperature (25° C.) with a charge and discharge voltage range of 1.5 to 4.3 V vs. Li/Li⁺, 0.1 C/0.1 C current rate.

At this time, the peaks at about 1656 cm⁻¹ and about 1701 cm⁻¹ in the pure caffeine spectrum correspond to C═O, C═C, and C═N in the caffeine molecule.

During the discharge process, the intensity of the corresponding peaks decreases, and during the charge process, the intensity of the corresponding peaks increases, which means that C═O, C═C, and C═N bonds reversibly participate in the charge compensation reaction during the charge and discharge processes.

Referring to FIG. 17, it is possible to confirm the XPS measurement results of C, N, and O elements in the caffeine molecule under the charge and discharge states.

During discharge, iii) it is possible to confirm that the peak intensity of C6 decreases and the peak moves to lower energy. In addition, this shows that the local structure around C6 changes and the electron density increases.

In the case of O, the intensity of the peak corresponding to C—O—Li increases, which means that the C6—O bond is broken and the C6—O—Li bond is formed. In addition, along with a decrease in the peak intensity of N3 and N4, a peak identified as oxidized N appears around 403.2 eV, and at the same time, ii) the C4, C8 peak positions move to lower energy, through which it is possible to confirm that the N3—Li—C8 bond is formed as N3 is oxidized.

The description of the disclosure is for illustrative purposes, and those skilled in the art will understand that it can be easily modified into other specific forms without changing the technical idea or essential features of the disclosure. Therefore, the embodiments described above should be understood as being exemplary in all respects and not limiting. For example, each component described as a single type may be implemented in a distributed manner, and likewise, components described as distributed may be implemented in a combined form.

The scope of the disclosure is indicated by the following claims, and all changes or modifications derived from the meaning and scope of the claims and their equivalent concepts should be interpreted as being included in the scope of the disclosure.

What is claimed is:

1. A positive electrode material for a lithium secondary battery, which has an amorphous thin film structure comprising a caffeine organic material, and is characterized by exhibiting reversible energy capacity through a reversible reaction in which lithium ions form and dissociate C6—O—Li and N3—Li—C8 bonds with the caffeine organic material.

2. The positive electrode material for a lithium secondary battery of claim 1, wherein the amorphous thin film structure has a thickness of 30 μm to 36 μm.

3. A lithium secondary battery comprising: a positive electrode; a negative electrode; and an ion exchange membrane positioned between the positive electrode and the negative electrode, wherein the positive electrode comprises the positive electrode material for a lithium secondary battery of claim 1.

4. A method for producing a positive electrode material for a lithium secondary battery, characterized by comprising:
forming a slurry by mixing a caffeine organic material, a conductive material, and a polymer binder with a solvent;
coating the formed slurry on a substrate;
drying the substrate coated with the slurry in a vacuum to form a film; and
forming a thin film by pressing the formed film.

5. The method for producing a positive electrode material for a lithium secondary battery of claim 4, wherein the forming of the slurry comprises:
ball-milling a mixture comprising the caffeine organic material and the conductive material to make the mixture amorphous; and
mixing the amorphous mixture with the polymer binder and the solvent.

6. The method for producing a positive electrode material for a lithium secondary battery of claim 4, wherein the ball-milling of the mixture to make the mixture amorphous is performed for 30 to 60 minutes at 200 to 400 rpm.

7. The method for producing a positive electrode material for a lithium secondary battery of claim 4, wherein the conductive material is at least one selected from the group consisting of Super P, Carbon black, CNT, and Ketjen Black.

8. The method for producing a positive electrode material for a lithium secondary battery of claim 4, wherein the polymer binder is at least one selected from PVDF and PAA.

9. The method for producing a positive electrode material for a lithium secondary battery of claim 4, wherein the solvent is N-methylpyrrolidone.

10. The method for producing a positive electrode material for a lithium secondary battery of claim 4, wherein in the forming of the slurry, the mixing ratio of the caffeine organic material, conductive material, and polymer binder corresponds to a weight ratio of 3:6:1 to 6:3:1.

11. The method for producing a positive electrode material for a lithium secondary battery of claim 4, wherein in the coating, the substrate is aluminum foil.

12. The method for producing a positive electrode material for a lithium secondary battery of claim 4, wherein the drying in a vacuum to form the film is performed for 10 to 15 hours at a temperature range of 60° C. to 80° C.

13. The method for producing a positive electrode material for a lithium secondary battery of claim 4, wherein in the forming of the thin film by pressing, the thickness of the thin film is 30 μm to 36 μm.
